(19) United States
(12) Patent Application Publication
(10) Pub. No.: US 2020/0104078 A1
(43) Pub. Date: Apr. 2, 2020

(54) IMAGE FORMING APPARATUS, RECORDING MEDIUM STORING CONTROL PROGRAM AND CONTROL METHOD

(71) Applicant: SHARP KABUSHIKI KAISHA, Sakai City (JP)

(72) Inventor: NAOYA ARIFUKU, Sakai City (JP)

(21) Appl. No.: 16/520,759

(22) Filed: Jul. 24, 2019

(30) Foreign Application Priority Data
Sep. 27, 2018 (JP) 2018-181324

(51) Int. Cl. G06F 3/12; G03G 15/00; G06K 15/02; H04N 1/00

(52) U.S. Cl. CPC G06F 3/1205; G03G 15/502; G06F 3/1257; G06F 3/1273; H04N 2201/0094; H04N 1/00474; H04N 1/00482; G06F 3/1267; G06K 15/1806

(57) ABSTRACT

This image forming apparatus includes an image former, and data of a print job executed by the image forming apparatus is registered in a print job table. In addition, the image forming apparatus includes a holding function of, when executing a print job based on print data transmitted from an external terminal, enabling the print job to be executed only when a user confirms the print job. When an error occurs while executing the print job, the image forming apparatus automatically deletes print job data based on print data acquired in a state where the holding function is enabled, among the print jobs based on the print data transmitted from the external terminal.

### BACKGROUND OF THE INVENTION

### Field of the Invention

The present invention relates to an image forming apparatus, a recording medium storing a control program, and a control method, and in particular, to an image forming apparatus, a recording medium storing a control program, and a control method with which print data transmitted from an external terminal is received and an image is formed on a recording medium in accordance with the received print data.

### Description of the Background Art

An example of this kind of background art is disclosed in Japanese Unexamined Patent Application Publication No. 2003-234882. When detecting a failure while printing the received document data, a received document processing apparatus of the background art notifies a user that a failure has occurred via a display device, and when the user performs a predetermined input operation from the input device, the received document processing apparatus stops the printing process, and stores, in a specific file storage area, the received document data as a file.

However, with the received document processing apparatus of the background art, since the print job cannot be canceled without a user's input instruction, there is a problem that the print job is not canceled even if an error occurs if the user is not near the received document processing apparatus or when the user does not notice the notification.

In addition, if cancellation of printing is not instructed, printing processing is executed in accordance with the received document data after the error is eliminated, and thus if a person who should receive a printed matter leaves before the error is eliminated, the printed matter may be taken away by another person, which causes a safety (security) issue.

Therefore, the main object of the present invention is to provide a novel image forming apparatus, a recording medium storing a novel control program, and a novel control method.

Another object of the present invention is to provide an image forming apparatus, a recording medium storing a control program, and a control method that can improve safety when performing printing on the basis of print data transmitted from an external terminal.

### SUMMARY OF THE INVENTION

A first invention is an image forming apparatus and includes an image former, receiver, switcher, registerer, detector, and deleter. The image former executes a print job in accordance with print job data registered in a print job table. The receiver receives print data transmitted from an external terminal. The switcher switches between enabling and disabling a holding function of executing the print job for the print data only when a predetermined user operation is received. The registerer registers, in the print job table, print job data with a holding function based on print data with a holding function that is received in a state where the holding function is enabled, among the print data received by the receiver, when the predetermined user operation is received. The detector detects a predetermined error not suitable for an execution of the print job. The deleter deletes the print job data with the holding function from the print job table when the predetermined error is detected by the detector.

A second invention is an image forming apparatus according to the first invention, and further includes a storage that stores the print data with the holding function, and when the predetermined user operation is received, the registerer reads the print data with the holding function from the storage, and registers the print job data with the holding function in the print job table.

A third invention is an image forming apparatus according to the first or second invention, and further includes a display, and a previewer that causes the display to preview a print image corresponding to the print data with the holding function.

A fourth invention is an image forming apparatus according to any one of the first to third inventions, and further includes a permitter that performs an authentication process of a person who intends to use the image forming apparatus and permits the predetermined user operation only for a person registered in advance.

A fifth invention is a non-transitory computer-readable recording medium storing a control program for an image forming apparatus including an image former that executes a print job in accordance with print job data registered in a print job table, the control program causing a processor of the image forming apparatus to function as: a receiver that receives print data transmitted from an external terminal; a switcher that switches between enabling and disabling a holding function of executing the print job for the print data only when a predetermined user operation is received; a registerer that registers, in the print job table, print job data with a holding function based on print data with a holding function that is received in a state where the holding function is enabled, among the print data received by the receiver, when the predetermined user operation is received; a detector that detects a predetermined error not suitable for an execution of the print job; and a deleter that deletes the print job data with the holding function from the print job table when the predetermined error is detected by the detector.

A sixth invention is a control method for an image forming apparatus including an image former that executes a print job in accordance with print job data registered in a print job table, and includes: (a) receiving print data transmitted from an external terminal; (b) switching between enabling and disabling a holding function of executing the print job for the print data only when a predetermined user operation is received; (c) registering, in the print job table, print job data with a holding function based on print data with a holding function that is received in a state where the holding function is enabled, among the print data received in the (a), when the predetermined user operation is received; (d) detecting a predetermined error not suitable for an execution of the print job; and (e) deleting the print job data with the holding function from the print job table when the predetermined error is detected in the (d).

According to the present invention, it is possible to improve safety when performing printing on the basis of print data transmitted from an external terminal.

The above object, other objects, features and advantages of the present invention will become more apparent from the following detailed description of the embodiments given with reference to the drawings.

### BRIEF DESCRIPTION OF THE DRAWINGS

FIG. 1 is a perspective view illustrating an appearance of an image forming apparatus which is an embodiment of the present invention.

FIG. 2 is a block diagram illustrating an electrical configuration of the image forming apparatus illustrated in FIG. 1.

FIG. 3 is a diagram illustrating an example of a home screen.

FIG. 4 is a diagram illustrating an example of the home screen including a confirmation window.

FIG. 5 is a diagram illustrating an example of a selection screen.

FIG. 6 is a diagram illustrating an example of the home screen including a notification window.

FIG. 7 is a diagram illustrating an example of a memory map of a RAM illustrated in FIG. 2.

FIG. 8 is a flowchart illustrating an example of a data reception process of a CPU illustrated in FIG. 2.

FIG. 9 is a flowchart illustrating an example of a job registration process of the CPU illustrated in FIG. 2.

FIG. 10 is a flowchart illustrating an example of a print process of the CPU illustrated in FIG. 2.

FIG. 11 is a diagram illustrating an example of a home screen including an authentication window in a second embodiment.

FIG. 12 is a flowchart illustrating a part of an example of a job registration process of the second embodiment.

FIG. 13 is a flowchart illustrating an example of a print process of a third embodiment.

### DESCRIPTION OF THE PREFERRED EMBODIMENTS

### First Embodiment

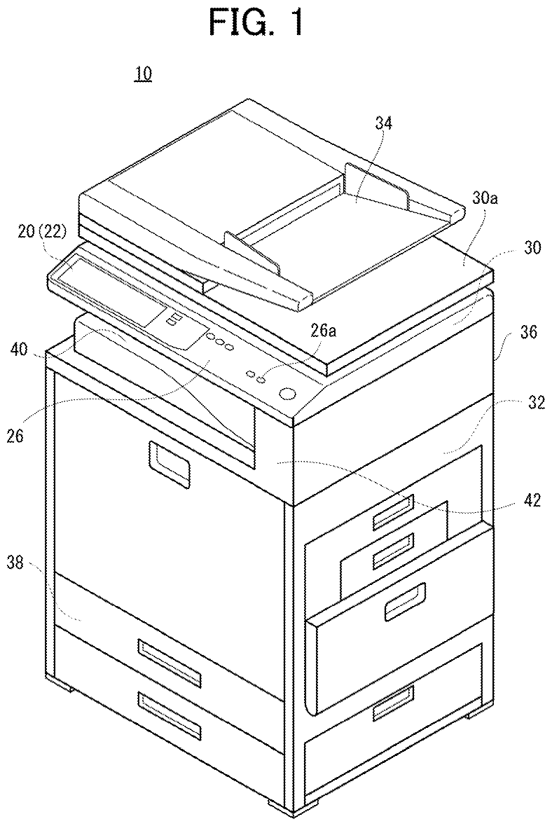

FIG. 1 is a perspective view illustrating an appearance configuration of an image forming apparatus 10 which is an embodiment of the present invention. Referring to FIG. 1, in the first embodiment, the image forming apparatus 10 is a multifunction peripheral (MFP) including a copying function, a printer function, a scanner function, a facsimile (FAX) function, and an internet fax (I-FAX) function, and the like. The present invention is not limited to a multifunction peripheral, and is applicable to another image forming apparatus capable of printing on the basis of print data transmitted from an external terminal, such as a printing apparatus (printer) and a facsimile apparatus.

In this specification, with a surface facing a user's standing position, that is, a surface on a side where an operation panel 26 described later is provided being anterior (front), an anterior-posterior (depth direction) of the image forming apparatus 10 and its components is defined, and a left-right direction (lateral direction) of the image forming apparatus 10 and its components is defined on the basis of a state where the image forming apparatus 10 is viewed from the user.

The image forming apparatus 10 includes an apparatus main body 36 including an image reader 30, an image former 32, a paper feeding device 38, and a paper output tray 40.

The image reader 30 includes a document placement table formed of a transparent material, and is incorporated in the apparatus main body 36. A document pressing cover 30a is attached above the document placement table via a hinge or the like so as to be openable and closable. A document placement tray 34 is provided in the document pressing cover 30a. In addition, an automatic document feeder (ADF) for automatically feeding a document placed on the document placement tray 34 is provided in the document pressing cover 30a.

In addition, the image reader 30 includes a light source, a plurality of mirrors, an imaging lens, a line sensor, and the like. The image reader 30 exposes a surface of a document by the light source, and guides reflected light reflected from the surface of the document into the imaging lens by the plurality of mirrors. Then, the reflected light is imaged on a light receiving element of the line sensor by the imaging lens. A luminance or chromaticity of the reflected light imaged on the light receiving element is detected by the line sensor, and read image data based on the image of the document surface is generated. As the line sensor, a charge coupled device (CCD), a contact image sensor (CIS), or the like is used.

The image former 32 is incorporated in the apparatus main body 36 and provided below the image reader 30. The image former 32 includes a photosensitive drum, a charging device, an exposure device, a developing device, a transfer device, a fixing device, and the like. The image former 32 forms an image on a recording medium (paper) conveyed from the paper feeding device 38 or the like by the electrophotographic method, and ejects the paper on which the image is formed to the paper output tray 40. Note that, as print image data for forming an image on a paper, print data transmitted from an external computer (external terminal) is used in addition to image data read by the image reader 30. The print data includes image data and document data. In addition, the external computer is a desktop PC, a notebook (laptop) PC, a tablet PC, a smartphone, another multifunction peripheral, another facsimile apparatus, and the like. Furthermore, the recording medium is not limited to a sheet made of a paper, and a sheet other than a paper, such as an OHP film, may also be used.

Although the detailed description is omitted, the image former 32 includes a color print function, and for each of Y (yellow), M (magenta), C (cyan), and K (black), an image forming station including a photosensitive drum, a charging device, a developing device, a transfer roller, and a cleaning device is configured. For example, the image forming apparatus 10 is a tandem type image forming apparatus, and in the image former 32, the image forming stations for each color are arranged in a line.

The paper output tray 40 is provided between the image reader 30 and the image former 32. A bottom surface of the paper output tray 40 is partitioned by the image former 32. In addition, a top surface of the paper output tray 40 is partitioned by the image reader 30. A left side surface (left side surface viewed from the front) of the paper output tray 40 is defined by a right side surface of a connection housing 42. That is, a front surface side, a back surface side, and a left side surface side of the paper output tray 40 open. The bottom surface of the paper output tray 40 has an inclined surface having a downward slope toward the connection housing 42 side.

In addition, an operation panel 26 is provided on a front surface side of the image reader 30. The operation panel 26 includes a display 22 with a touch panel 20 and a plurality of operation buttons 26a.

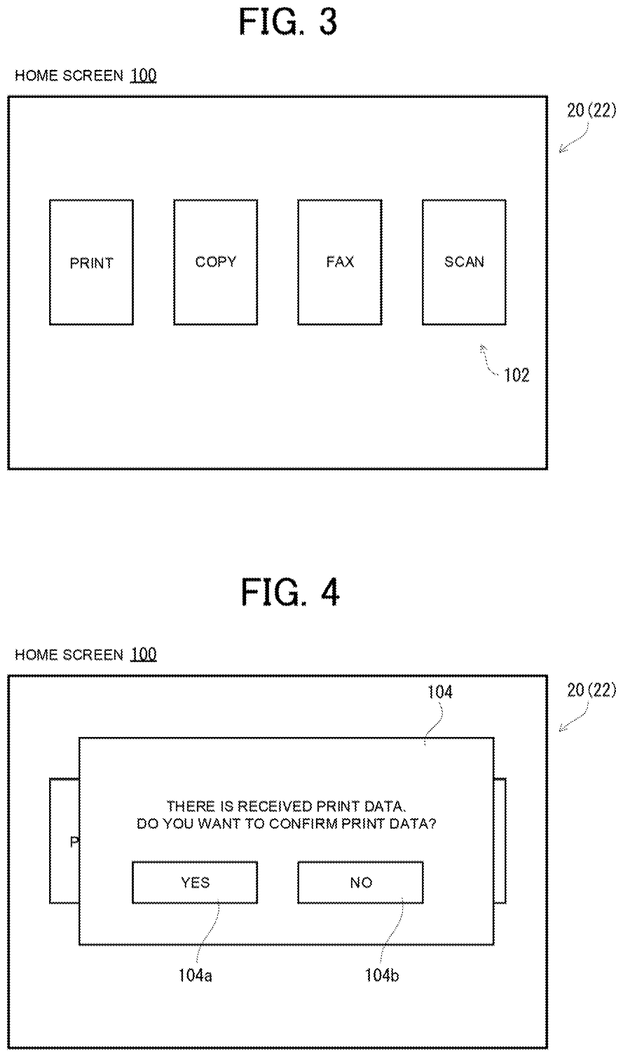

Software keys, messages, and the like for receiving various settings, print instructions, and the like from the user are displayed on the display 22 with the touch panel 20. On the display 22, various operation screens such as a home screen 100 (see FIG. 3) which is a screen for selecting a desired job from various jobs executable by the image forming apparatus 10 are displayed. Note that, in this first embodiment, the job means copying (including scanning of a document), printing, sending a fax, and the like.

The operation buttons 26a are hardware keys, and include, for example, a home key, a power saving key, a main power key, and the like. The home key is a key for displaying a home screen on the display 22. The power saving key is a key for switching between a power saving state where power consumption is limited (power saving mode) and a normal state where power consumption is not limited (normal mode). Note that, the operation buttons 26a may be software keys. In this case, the operation buttons 26a are displayed on the display 22 with the touch panel 20.

The software keys refer to, for example, keys (icon) reproduced as software on a display surface of the display 22 with the touch panel 20. On the other hand, the hardware keys refer to keys (button) provided as a physical device. In addition, an operation input in the operation panel 26 means an operation input to each part of the operation panel 26, such as an operation input with the software keys (for example, a touch input to the touch panel 20) and an operation input with the hardware keys (a button operation of the operation buttons 26a).

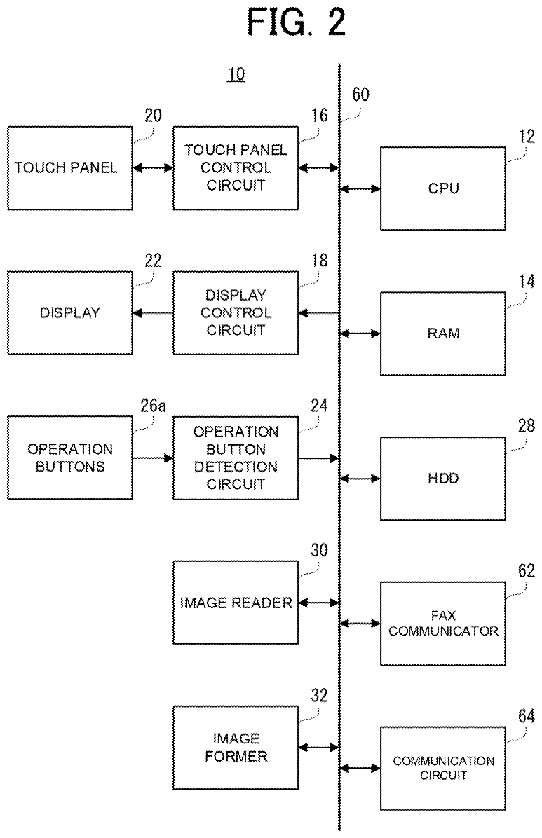

FIG. 2 is a block diagram illustrating an electrical configuration of the image forming apparatus 10 illustrated in FIG. 1. Referring to FIG. 2, the image forming apparatus 10 includes a CPU 12. To the CPU 12, a RAM 14, a touch panel control circuit 16, a display control circuit 18, an operation button detection circuit 24, an HDD 28, the image reader 30, the image former 32, a FAX communicator 62, and a communication circuit 64 are connected via a bus 60. In addition, the touch panel 20 is connected to the touch panel control circuit 16, the display 22 is connected to the display control circuit 18, and the operation buttons 26a are connected to the operation button detection circuit 24.

The CPU 12 is in charge of overall control of the image forming apparatus 10. The RAM 14 is used as a work area and a buffer area of the CPU 12.

The HDD 28 is a main storage device of the image forming apparatus 10 and appropriately stores a control program and various data for the CPU 12 to control an operation of each part of the image forming apparatus 10. However, as an alternative to or along with the HDD 28, another non-volatile memory such as an SSD, a flash memory, and an EEPROM may be used.

The touch panel control circuit 16 applies a required voltage or the like to the touch panel 20, detects a touch operation (touch input) within a touch effective range of the touch panel 20, and outputs touch coordinate data indicating a position of the touch input to the CPU 12.

The touch panel 20 is a general-purpose touch panel, and an any type of touch panel, such as a capacitive type, an electromagnetic induction type, a resistive film type, and an infrared type can be used. In this first embodiment, a capacitive touch panel is used as the touch panel 20, and the touch panel 20 is provided on the display surface of the display 22. However, a touch panel display in which the touch panel 20 and the display 22 are integrally formed may be used.

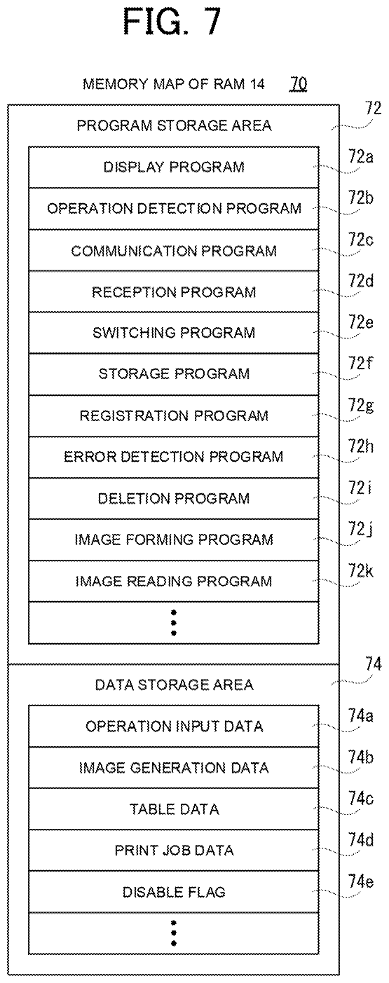

The display control circuit 18 includes a GPU, a VRAM, and the like, and under an instruction of the CPU 12, the GPU uses image generation data 74b (see FIG. 7) stored in the RAM 14 to generate, in the VRAM, display image data for displaying various screens on the display 22, and outputs the generated display image data to the display 22. As the display 22, an LCD or an electro-luminescence (EL) display can be used, for example.

The operation button detection circuit 24 outputs, to the CPU 12, an operation signal or operation data corresponding to an operation of the operation buttons 26a described above.

The FAX communicator 62 includes a facsimile modem (FAX modem) and a network control unit (NCU), and is connected to a public communication line such as Public Switched Telephone Networks (PSTN) via a telephone line, a circuit switch, and the like. The FAX modem modulates encoded transmission image data into an analog signal of a format suitable for transmission on the PSTN on the basis of a standard of facsimile communication (FAX communication), and demodulates an analog signal from another FAX machine to acquire received image data. The NCU performs line control of closing and opening of the PSTN, and connects a FAX modem to the PSTN. The NCU also transmits and receives image data and control signals in accordance with a predetermined FAX communication protocol, and performs an automatic call process and an automatic call reception process for FAX communication.

The communication circuit 64 is a communication circuit for connecting to a network such as the Internet. This communication circuit 64 is a wired communication circuit or a wireless communication circuit, and communicates with an external computer via a network in accordance with an instruction from the CPU 12. The communication circuit 64 is also a communication circuit for transmitting and receiving I-FAX via a network.

The electrical configuration of the image forming apparatus 10 illustrated in FIG. 2 is merely an example, and is not required to be limited to this. For example, the image forming apparatus 10 is provided with a jam sensor for detecting a paper jam in the image former 32, a paper sensor for detecting a remaining amount of papers in the paper feeding device 38, and the like. In addition, the image forming apparatus 10 may be provided with a speaker that outputs sound or voice (synthetic voice).

In an image forming apparatus having such a configuration, if an error occurs during execution of a print job based on print data (hereinafter referred to as “received print data”) transmitted from an external computer (external terminal), a user is notified via a display that an error has occurred, and when the user instructs to cancel printing, the printing may be canceled and the received print data may be saved as a file.

However, in a conventional image forming apparatus, since a print job cannot be canceled without a user's input instruction, there is a problem that the print job is not canceled when the user is not near the image forming apparatus or when the user does not notice the notification. In addition, if cancellation of the print job is not instructed, the print job based on the received print data is executed (resumed) after the error is eliminated, and thus if a person who should receive a printed matter leaves before the error is eliminated, the printed matter may be taken away by another person, which causes a safety (security) issue.

Therefore, in the image forming apparatus 10 of this first embodiment, when a failure occurs during execution of a print job, data of a print job with emphasis on safety (security) of print jobs based on received print data transmitted from an external terminal is automatically deleted.

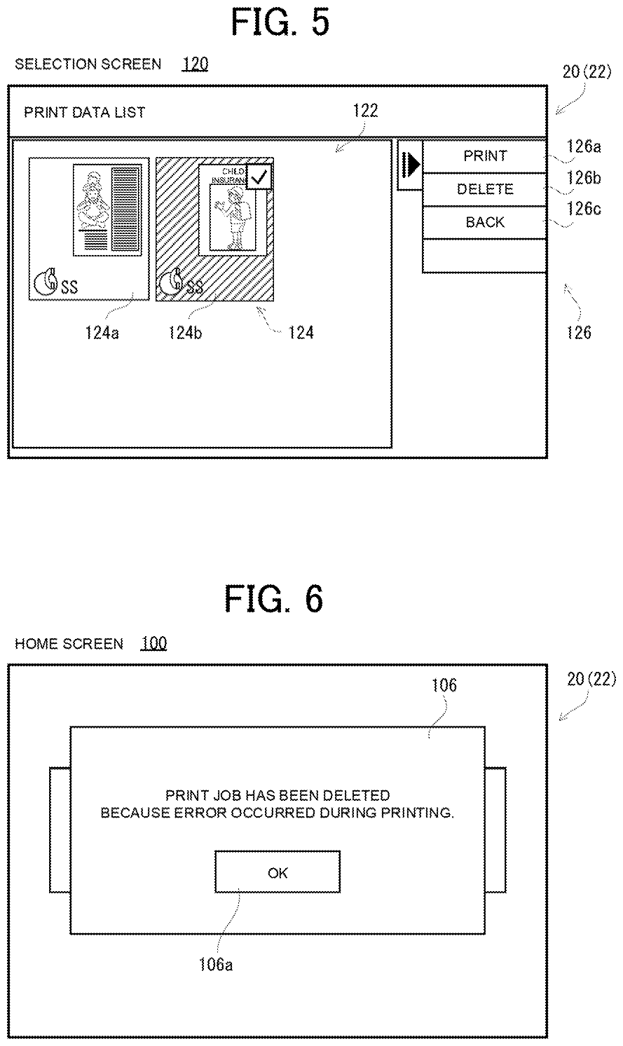

Hereinafter, an operation example of the image forming apparatus 10 will be described with reference to FIGS. 3 to 6 and the like. FIG. 3 is a diagram illustrating an example of the home screen 100. FIG. 4 is a diagram illustrating an example of the home screen 100 including a confirmation window 104. FIG. 5 is a diagram illustrating an example of a selection screen 120. FIG. 6 is a diagram illustrating an example of the home screen 100 including a notification window 106.

As described above, the image forming apparatus 10 is a multifunction peripheral having various functions, and can execute copy jobs, print (print) jobs, scan jobs, fax jobs, I-FAX jobs, and the like. When the image forming apparatus 10 is powered on and is in a standby state where each function can be executed, a home screen 100 such as that illustrated in FIG. 3 is displayed on the display 22 of the image forming apparatus 10. This home screen 100 displays an image of a job selection key (icon) 102 for selecting each job, such as copy, print, FAX (including ordinary FAX and I-FAX), and scan and displaying an operation screen (setting screen) for each job.

For example, a user can operate (touch) the job selection key 102 to instruct execution of a desired job. Therefore, the image forming apparatus 10 executes each job in accordance with the user's instruction. In addition, when receiving received print data transmitted from an external computer, such as data about a print job, data about a fax job, or data about an I-FAX job, the image forming apparatus 10 executes a print job (a print job, a fax job and an I-FAX job) based on the received print data.

However, although details will be described later, a data storage area 74 of the RAM 14 stores a print job table used for a so-called print queue function of storing print jobs and controlling printing in a predetermined order. The data of a print job (print job data) executed by the image forming apparatus 10 is registered in the print job table (stored in the print queue). Although not illustrated, in the print job table, identification (ID) information for identifying the print job, a priority of the print job, and the like are described. In principle, the priorities of print jobs are set in an order of registration in the print job table. In addition, when a print job is finished, print job data corresponding to the finished print job is deleted (erased) from the table.

Moreover, the image forming apparatus 10 of the first embodiment includes a retention function (holding function) by which, when executing a print job based on received print data transmitted from an external terminal, a print job is not executed immediately after acquisition of the received print data (is not registered in the print job table), but the print job becomes executable only when confirmed by the user. As described above, when the holding function is effective, it is considered that safety (security) is emphasized because confirmation by the user is required to execute the print job. Although not illustrated, enabling/disabling of the holding function can be switched by a predetermined key operation. The key (holding function switching key) for switching the enabling/disabling of the holding function may be a hardware key or a software key.

Then, in the image forming apparatus 10, when the received print data is acquired (received) in a state where the holding function disabled, the print job data (normal print job data) based on the received print data (normal received print data) is automatically registered in the print job table. However, the normal print job data is associated with information indicating that it is normal print job data, that is, it does not have a holding function.

Meanwhile, in the image forming apparatus 10, when the received print data is received in a state where the holding function is enabled, that is, in a state where safety (security) is emphasized, the received print data is treated as received print data with a holding function (corresponding to print data with a holding function). The received print data with the hold function is temporarily stored in the HDD 28 after being received, and print job data based on the received print data with the hold function (print job data with the holding function) is not automatically registered in the print job table.

Then, when there is a predetermined user operation (print instruction), the received print data with the holding function is read from the HDD 28, and the print job data with the holding function based on the received print data with the holding function is registered in the print job table. Note that, the print job data with the holding function is associated with information indicating that the print job data is the print job data with the holding function, that is, the print job data has the holding function.

In the image forming apparatus 10 of the first embodiment, when the received print data with the holding function is stored in the HDD 28, the home screen 100 including the confirmation window 104 such as that illustrated in FIG. 4 is displayed on the display 22. The confirmation window 104 is a window displayed when the display on the display 22 transitions from an operation screen other than the home screen 100 to the home screen 100, and is displayed on a central part of a display area of the display 22, being superimposed in front of the home screen 100. That is, the confirmation window 104 is displayed in a pop-up.

The confirmation window 104 is a screen (window) for confirming the received print data with the holding function stored in the HDD 28 and performing a print instruction for a print job (the print job with the holding function) based on the received print data with the holding function. The confirmation window 104 displays a message prompting the user to confirm the received print data with the holding function (for example, a message such as “THERE IS RECEIVED PRINT DATA. DO YOU WANT TO CONFIRM THE PRINT DATA?”) In addition, the confirmation window 104 displays a “YES” button 104a for displaying a list of the received print data with the holding function and a “NO” button 104b for not displaying the list of the received print data with the holding function.

The confirmation window 104 cannot be operated except by touching the “YES” button 104a or the “NO” button 104b, and other operations cannot be performed.

When the “NO” button 104b is selected, the confirmation window 104 is hidden and returns to the home screen 100. Meanwhile, when the “YES” button 104a is selected, the display 22 displays the selection screen 120 such as that illustrated in FIG. 5. This selection screen 120 includes a list display portion 122 and a plurality of instruction icons 126.

The list display portion 122 displays a list of selection icons 124 corresponding to the received print data with the holding function stored in the HDD 28. The selection icon 124 displays a thumbnail image based on an image (printed image) included in the received print data with the holding function and a character string and a graphic indicating information related to the printed image. If the received print data with the holding function includes a plurality of images (pages), the selection icons 124 are displayed. In the example illustrated in FIG. 5, the list display portion 122 displays a selection icon 124a corresponding to the received print data with a first holding function and a selection icon 124b corresponding to the received print data with a second holding function.

In the selection screen 120, when the selection icon 124 is touched by the user, the touched selection icon 124 is selected, that is, the received print data with the holding function corresponding to the selection icon 124 is selected. As illustrated in FIG. 5, when the selection icon 124 is touched, a display mode changes, for example, a check mark is displayed or a pattern is displayed on the touched selection icon 124 (for example, the selection icon 124b). In this way, the user can recognize the icon selected by the user.

In the example illustrated in FIG. 5, a print icon 126a, a delete icon 126b and a back icon 126c are displayed as the plurality of the instruction icons 126.

A function to execute a print job with a holding function (to perform printing instruction) based on the selected received print data with a holding function is assigned to the print icon 126a. Therefore, when the print icon 126a is touched in a state where the selection icon 124 displayed on the list display portion 122 is selected, print job data with a holding function based on the received print data with a holding function corresponding to the selected icon 124 is registered in the print job table. Although not illustrated, the selection icon 124 corresponding to received print data with a holding function corresponding to print job data with a holding function registered in the print job table may be configured to change a display mode in such a manner that the user can see that the print job has been registered in the print job table. Then, when the print job with the holding function is finished, print job data with the holding function corresponding to the print job with the holding function is deleted from the print job table, and at the same time, the received print data with the holding function corresponding to the print job data with the holding function is deleted from the HDD 28, and in addition, the selection icon 124 corresponding to the received print data with the holding function is deleted (hidden).

The delete icon 126b is assigned a function for deleting the selected received print data with the holding function. When the delete icon 126b is touched, the received print data with the held function corresponding to the selected icon 124 being selected is deleted from the HDD 28, and the icon 124 corresponding to the received print data with the held function is deleted.

The back icon 126c is assigned a function for closing the selection screen 120 and returning to the home screen 100. For example, when the back icon 126c is touched in the selection screen 120, the home screen 100 is displayed on the display 22.

In addition, in the image forming apparatus 10 of the first embodiment, a predetermined error (hereinafter, sometimes referred to as a “first type error”) that is not suitable for the execution of a print job may occur. When such a first type error occurs, if a print job is being executed, a print job is stopped (suspended). In this case, among the print job data registered in the print job table, print job data with a holding function is automatically deleted. However, print job data other than print job data with a holding function, that is, print job data based on normal print job data or image data read by the image reader 30 is not deleted.

Therefore, when print job data with a hold function and print job data other than the print job data with the hold function are registered in the print job table, the priority of the print job data other than the print job data with the holding function is raised.

In addition, even if the first type error occurs during execution of a print job with a holding function, print job data with the holding function is deleted. Therefore, when the first type error occurs during execution of the print job with the holding function, the print job with the holding function is canceled on the way. Meanwhile, when the first type error occurs during execution of a print job based on normal print job data (normal print job), the normal print job is temporarily suspended, but will be resumed if the first type error is eliminated.

In the image forming apparatus 10 of the first embodiment, when print job data with a holding function is deleted, the home screen 100 including the notification window 106 such as that illustrated in FIG. 6. is displayed on the display 22. The notification window 106 is a window that is displayed when the display 22 transitions from an operation screen other than the home screen 100 to the home screen 100, and is displayed on the central part of the display area of the display 22, being superimposed in front of the home screen 100.

The notification window 106 is a screen (window) for notifying the user that the print job data with the holding function has been deleted, and the notification window 106 displays a message that the print job data with the holding function has been deleted (for example, a message such as “THE PRINT JOB HAS BEEN DELETED BECAUSE AN ERROR OCCURRED DURING PRINTING.”, etc.). In addition, the notification window 106 displays an “OK” button 106a for closing the notification window 106. The notification window 106 is configured in such a manner that operations other than touching the “OK” button 106a cannot be performed, and other operations cannot be performed.

When the “OK” button 106a is selected, the notification window 106 is hidden, and the display 22 displays the home screen 100 including the confirmation window 104 such as that illustrated in FIG. 4. Here, since the received print data with the holding function that is an origin of the deleted print job data with the holding function is not deleted from the HDD 28, the user can specify the received print data with the holding function to give a print instruction again.

The above-described operation of the image forming apparatus 10 is implemented by the CPU 12 executing a control program stored in the RAM 14. A specific process will be described later with the use of a flowchart.

FIG. 7 is a diagram illustrating an example of a memory map 70 of the RAM 14 illustrated in FIG. 2. As illustrated in FIG. 7, the RAM 14 includes a program storage area 72 and a data storage area 74. As described above, a control program is stored in the program storage area 72 of the RAM 14. The control program includes a display program 72a, an operation detection program 72b, a communication program 72c, a reception program 72d, a switching program 72e, a storage program 72f, a registration program 72g, an error detection program 72h, a deletion program 72i, an image forming program 72j, and an image reading program 72k.

The display program 72a is a program for displaying various screens such as the home screen 100 or the selection screen 120 on the display 22 with the use of image generation data 74b described later.

The operation detection program 72b is a program for detecting an operation on each part of the image forming apparatus 10. For example, the operation detection program 72b is a program for acquiring touch coordinate data output from the touch panel 20 and detecting that a software key included in various screens displayed on the display 22 has been operated. In addition, the operation detection program 72b is also a program for detecting an operation input from the operation buttons 26a.

The communication program 72c is a program for communicating with an external computer via a network.

The reception program 72d is a program for receiving received print data transmitted from the external computer. However, the communication program 72c is executed at the time of the reception.

The switching program 72e is a program for turning on/off a disable flag 74e in accordance with an operation of a holding function switching key for switching between enabling/disabling of a holding function. That is, the switching program 72e is a program for switching between enabling/disabling of a holding function.

The storage program 72f is a program for storing, in the HDD 28, received print data with a holding function that is received in a state where the holding function is enabled.

The registration program 72g is a program for registering, in the print job table, print job data with a holding function based on received print data with a holding function, when a print instruction for a print job based on the received print data with the holding function is received.

The error detection program 72h is a program for determining whether the first type error such as paper jam, toner runout, paper runout or the like has occurred in accordance with an output of the jam sensor and the paper sensor.

The deletion program 72i is a program for deleting print job data with a holding function among the print job data registered in the print job table, when it is determined that the first type error has occurred. The deletion program 72i is also a program for deleting, from the print job table, print job data corresponding to a finished print job. Moreover, the deletion program 72i is also a program for, when a print job with a holding function is finished, deleting from the HDD 28 received print data with a holding function corresponding to the print job with the holding function.

The image forming program 72j is a program for controlling the image former 32 to print a multi-color or single color image on a paper. In addition, the image forming program 72j is also a program for stopping a print job when it is determined that the first type error has occurred and starting (resuming) the print job when it is determined that the first type error has been eliminated.

The image reading program 72k is a program for controlling the image reader 30 to read an image of a document and outputting an image signal (image data) corresponding to the read image.

Although not illustrated, the program storage area 72 also stores programs for selecting and executing various functions of the image forming apparatus 10, and the like.

The data storage area 74 of the RAM 14 stores operation input data 74a, image generation data 74b, table data 74c, print job data 74d, a disable flag 74e, and the like.

The operation input data 74a is, for example, touch coordinate data or/and operation data detected (acquired) in accordance with the operation detection program 72b. The detected touch coordinate data or/and operation data are stored in time series.

The image generation data 74b is data such as polygon data or texture data for generating display image data corresponding to various screens such as the home screen 100 or the selection screen 120 displayed on the display 22. In addition, the generated data 74b also includes, for example, image data of a software key, or the like.

The table data 74c is data of the above-described print job table or the like. The print job data 74d is data of a print job registered in the print job table, and for each print job, includes a print image for forming an image on a paper, information on various settings at the time of printing, and information on whether the data has a holding function. The disable flag 74e is a flag for determining whether the holding function is disabled. When the disable flag 74e is on, the holding function is disabled, and when the disable flag 74e is off, the holding function is enabled.

Although not illustrated, the data storage area 74 stores other data required for executing the control program, and is provided with a timer (counter) and a register required for executing the control program.

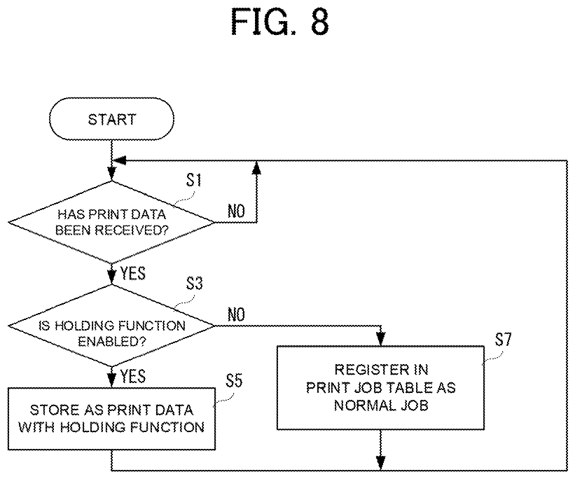

FIG. 8 is a flowchart illustrating an example of a data reception process of the CPU 12 illustrated in FIG. 2. The data reception process is started when the power of the image forming apparatus 10 is turned on.

As illustrated in FIG. 8, when the data reception process is started, the CPU 12 determines in step S1 whether received print data transmitted from an external computer has been received. If “NO” in the step S1, that is, if it is determined that the received print data is not received, the process directly returns to the same step S1. Meanwhile, if “YES” in the step S1, that is, if it is determined that the received print data has been received, it is determined whether a holding function is enabled in step S3. Here, the CPU 12 determines whether the disable flag 74e is off.

If “YES” in the step S3, that is, if the disable flag 74e is off and the holding function is enabled, the received print data received is stored in the HDD 28 as received print data with a holding function in step S5, and the process returns to the step S1. Meanwhile, if “NO” in the step S3, that is, if the disable flag 74e is on and the holding function is disabled, print job data based on the received print data is registered in the print job table as normal print job data in step S7, and the process returns to the step S1.

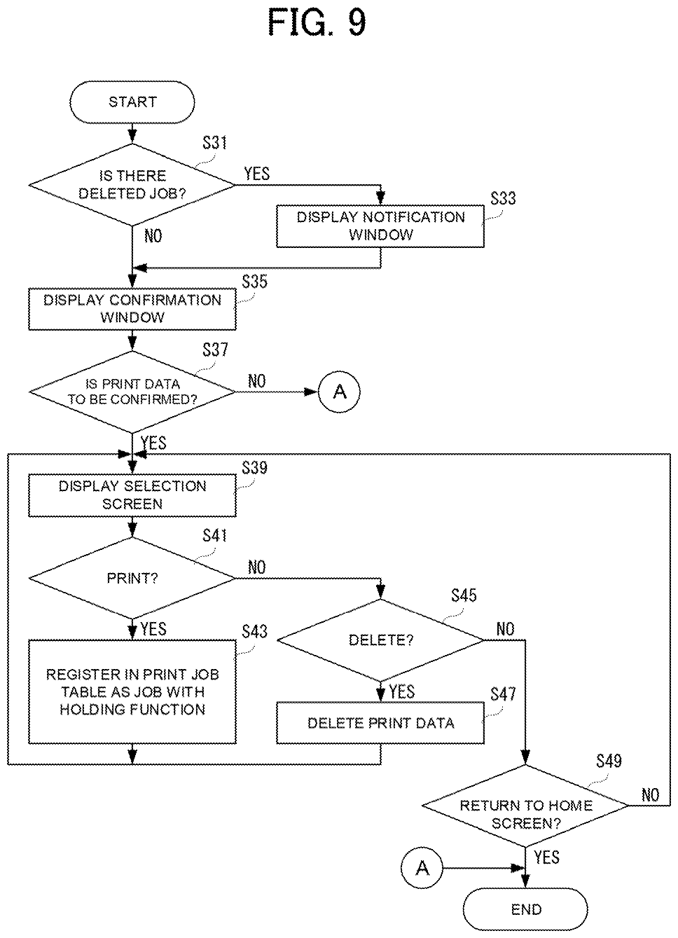

Next, a job registration process executed by the CPU 12 of the image forming apparatus 10 will be described. FIG. 9 is a flowchart illustrating an example of the job registration process of the CPU 12 illustrated in FIG. 2. This registration process is started when transitioning from an operation screen other than the home screen 100 to the home screen 100 in a state where received print data with a function is stored in the HDD 28, and is executed in parallel with the above-described data reception process.

As illustrated in FIG. 9, when the job registration process is started, the CPU 12 determines in step S31 whether there is print job data with a holding function deleted (deleted in step S71 described later) before the job is finished. If “YES” in the step S31, that is, if it is determined that there is print job data with a holding function deleted before the job is finished, the notification window 106 is displayed being superimposed in front of the home screen 100 in step S33, and the process proceeds to step S35. Meanwhile, if “NO” in the step S31, that is, if it is determined that there is no print job data with a holding function deleted before the job is finished, the confirmation window 104 displayed being superimposed in front of the home screen 100 in step S35, and it is determined whether content of the received print data with the holding function is to be confirmed in step S37. Here, the CPU 12 determines whether the “YES” button 104a included in the confirmation window 104 has been touched.

If “NO” in the step S37, that is, if it is determined that the “NO” button 104b is touched and the content of the received print data with the holding function is not to be confirmed, the job registration process ends. When the process is finished, the display 22 displays the normal home screen 100 (see FIG. 3) in which the confirmation window 104 is not displayed.

Meanwhile, if “YES” in the step S37, that is, if it is determined that the content of the received print data with the holding function is to be confirmed, the selection screen 120 is displayed on the display 22 in step S39, and it is determined whether a print job with a holding function based on the received print data with a holding function is to be executed in step S41. Here, the CPU 12 determines whether the print icon 126a has been touched in a state where the selection icon 124 displayed on the list display portion 122 is selected.

If “YES” in the step S41, that is, if it is determined that the print job with the holding function is to be executed, print job data based on the received print data with the holding function specified by the user is registered in the print job table as print job data with the holding function in step S43, and the process returns to the step S39. Meanwhile, if “NO” in the step S41, it is determined in step S45 whether the received print data with the holding function is to be deleted. Here, the CPU 12 determines whether the delete icon 126b has been touched in a state where the selection icon 124 displayed on the list display portion 122 is selected.

If “YES” in the step S45, that is, if it is determined that the received print data with the holding function is to be deleted, the received print data with the holding function selected by the user is deleted in step S47, and the process returns to the step S39. Meanwhile, if “NO” in the step S45, it is determined in step S49 whether to return to the home screen 100. Here, the CPU 12 determines whether the back icon 126c is has been touched.

If “NO” in the step S49, that is, if it is determined not to return to the home screen 100, the process returns to the step S39. Meanwhile, if “YES” in the step S49, that is, it is determined to return to the home screen 100, the job registration process is finished, and the screen returns to the home screen 100.

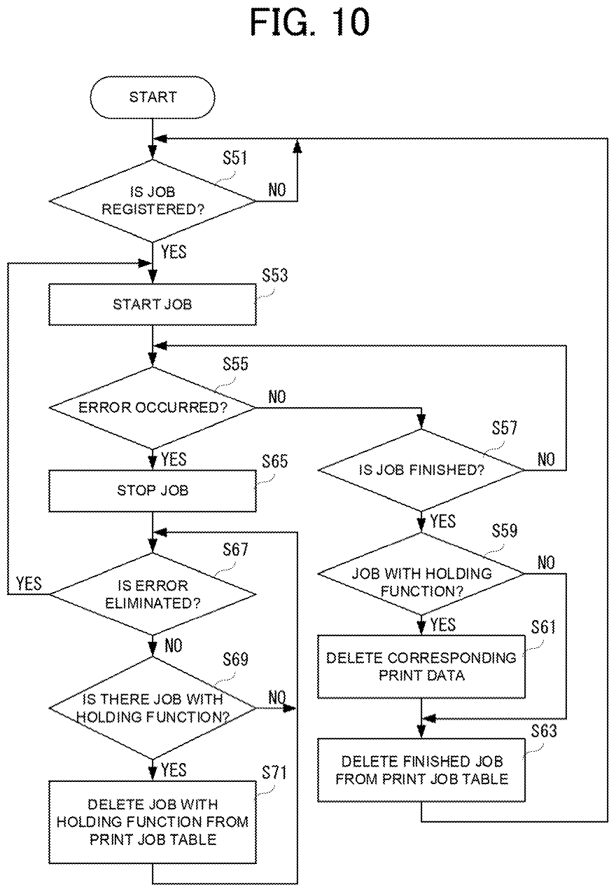

Next, a print process performed by the CPU 12 of the image forming apparatus 10 will be described. FIG. 10 is a flowchart illustrating an example of a print process of the CPU 12 illustrated in FIG. 2. This print process is started when the power of the image forming apparatus 10 is turned on, and is executed in parallel with the data reception process and the job registration process described above.

As illustrated in FIG. 10, when the print process is started, the CPU 12 determines whether print job data is registered in the print job table in step S51. If “NO” in the step S51, that is, if it is determined that the print job data is not registered in the job table, the process returns to the same step S51. Meanwhile, if “YES” in the step S51, that is, it is determined that the print job data is registered in the print job table, the print job is started in accordance with print job data having the highest priority in step S53, and it is determined in step S55 whether the first type error has occurred.

If “NO” in the step S55, that is, if it is determined that the first type error has not occurred, it is determined in step S57 whether the print job started in the step S53 is finished. If “NO” in the step S57, that is, if it is determined that the print job is not finished, the process returns to the step S55. Meanwhile, if “YES” in the step S57, that is, if it is determined that the print job is finished, it is determined in step S59 whether the finished print job is a print job with a holding function. Here, the CPU 12 determines whether the print job data of the finished print job is associated with information indicating that the print job data has a holding function.

If “NO” in the step S59, that is, if it is determined that the finished print job is a normal print job, the process proceeds to step S63. Meanwhile, if “YES” in the step S59, that is, if it is determined that the finished print job is a print job with a holding function, received print data with a hold function corresponding to the finished print job with the hold function is deleted from the HDD 28 in step S61, and the process proceeds to step S63. In the step S63, print job data corresponding to the finished print job is deleted from the print job table, and the process returns to the step S51.

In addition, if “YES” in the step S55, that is, if it is determined that the first type error has occurred, the print job is stopped (suspended) in step S65, and it is determined in step S67 whether the first type has been eliminated. Here, the CPU 12 determines whether the print job can be performed in accordance with an output of various sensors. If “YES” in the step S67, that is, it is determined that the first type error has been eliminated, the process returns to the step S53, and the print job is started (resumed).

If “NO” in the step S67, that is, if it is determined that the first type error is not eliminated, it is determined in step S69 whether there is a print job with a holding function. Here, it is determined whether print job data with a holding function is registered in the print job table. If “NO” in the step S69, that is, if it is determined that there is no print job with a holding function, the process returns to the step S67. Meanwhile, if “YES” in the step S69, that is, if it is determined that there is a print job with a holding function, print job data with the holding function is deleted in step S71, and the process returns to the step S67.

According to this first embodiment, when an error occurs during execution of a print job, of print jobs based on received print data transmitted from an external terminal, print job data with a hold function based on received print data with a hold function received with emphasis on safety is automatically deleted. Therefore, safety when printing is performed on the basis of the print data transmitted from the external terminal can be improved.

In addition, according to the first embodiment, even if the print job data with the holding function is deleted, since received print data with a holding function corresponding to the print job data with the holding function is stored in the HDD 28 until the print job is finished normally, a user can specify the received print data with the holding function again to give a print instruction. Therefore, in addition to the safety, convenience can be improved.

Furthermore, according to the first embodiment, since the confirmation window 104 including a thumbnail image based on an image (print image) included in the received print data with the holding function and the information related to the print image is displayed on the display 22, it is easy for the user to confirm the content of the received print data with the holding function.

### Second Embodiment

An image forming apparatus 10 according to a second embodiment is the same as that of the first embodiment except that an authentication process of a user who intends to use the image forming apparatus 10 is performed, and a print instruction for a print job with a holding function is permitted only for a user registered in advance, and therefore, the content different from the first embodiment will be described, and redundant description will be omitted.

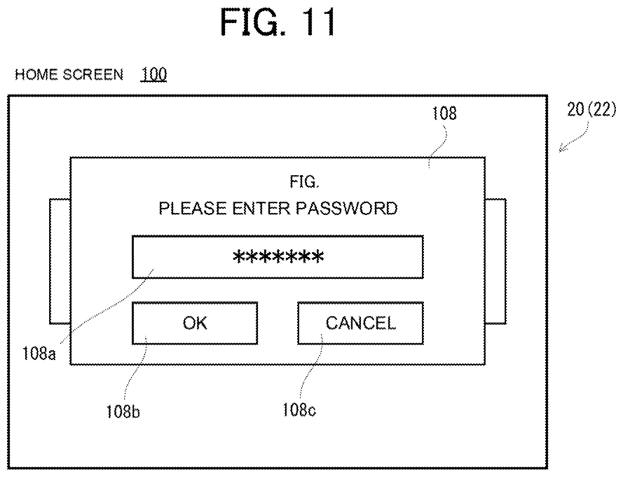

FIG. 11 is a diagram illustrating an example of a home screen 100 including an authentication window 108 in the second embodiment. In an image forming apparatus 10 of the second embodiment, when received print data with a holding function is stored in the HDD 28, the display 22 displays the home screen 100 including the authentication window 108 such as that illustrated in FIG. 11. The authentication window 108 is a window displayed when the “YES” button 104a is selected in the confirmation window 104, and is displayed in the central part of the display area of the display 22, being superimposed in front of the home screen 100.

The authentication window 108 is a screen for inputting a password for determining whether a user who intends to use the image forming apparatus 10 is a user registered in advance (registered user). The authentication window 108 displays a message prompting the user to input a password (for example, a message such as “PLEASE ENTER A PASSWORD”), an input box 108a, an “OK” button 108b, and a “CANCEL” button 108c.

The password (character string) input by operating the touch panel 20 or the operation button 26a is rendered in the input box 108a. However, a character “*” is displayed in the input box 108a instead of the input character. Thus, in this embodiment, the input character itself is not displayed. This is to prevent a third party from seeing the password by displaying the input password as it is. However, since a number of the character “*” displayed is increased according to the number of characters input, the user can recognize the number of characters (number of digits) of the password (being input).

A function to start the authentication process is assigned to the “OK” button 108b. When the “OK” button 108b is touched, it is determined whether the password (input password) input in the input box 108a matches a password (registered password) registered in advance.

When the input password and the registered password match, the display 22 displays the selection screen 120 such as that illustrated in FIG. 5. That is, confirmation of the received print data with the holding function and a printing instruction for a print job with the holding function can be performed.

Meanwhile, if the input password and the registration password do not match, the authentication window 108 is closed, and the normal home screen 100 (see FIG. 3) in which the confirmation window 104 is not displayed is displayed. In addition, also when the “CANCEL” button 108c is touched, the authentication window 108 is closed, and the normal home screen 100 is displayed. In these cases, the user cannot give a print instruction for the print job with the holding function. That is, a user other than the user registered in advance cannot give a print instruction for the print job with the holding function.

Moreover, in the second embodiment, in order to perform the operation as described above, a control program stored in the RAM 14 of the image forming apparatus 10 includes an authentication program (permission program) that determines whether the input password matches the registered password. In addition, the data storage area 74 of the RAM 14 stores data about the registration password (registration password data). The above operation of the image forming apparatus 10 is implemented by the CPU 12 executing the control program including the authentication program.

While a job registration process in the second embodiment will be described below with the use of a flowchart, the same processes as the job registration process described in the first embodiment have the same reference numerals, and redundant content will be omitted or briefly described.

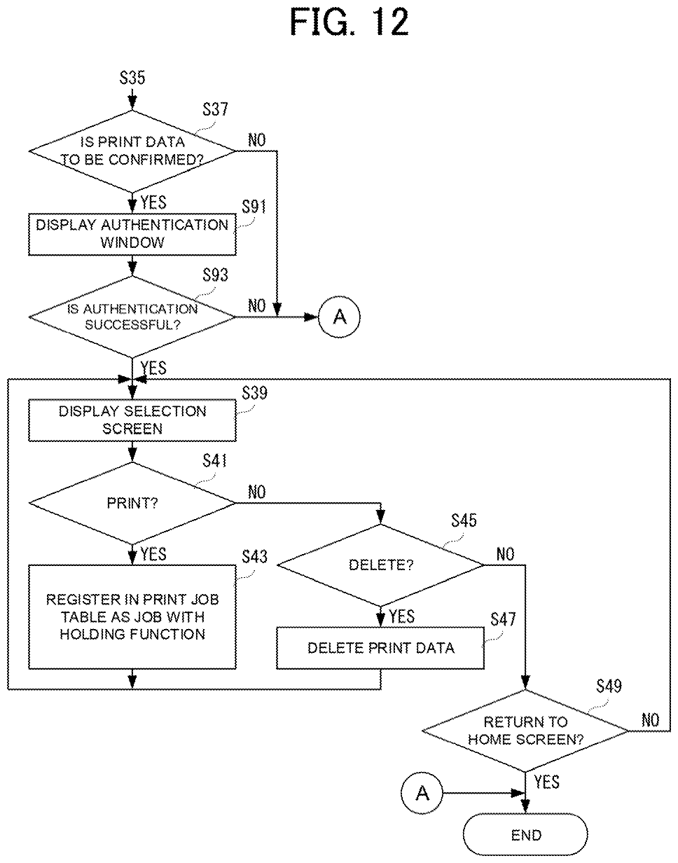

FIG. 12 is a flowchart illustrating a part of an example of a job registration process of the second embodiment. As illustrated in FIG. 12, when the CPU 12 starts the job registration process, if “YES” in step S37, the authentication window 108 is superimposed in front of the home screen 100 and displayed in step S91, and it is determined in step S93 whether the authentication is successful. Here, it is determined whether the password input in the input box 108a matches the password registered in advance. If “YES” in the step S93, that is, if the authentication is successful, the process proceeds to step S39. Meanwhile, if “NO” in the step S93, that is, the authentication fails, the job registration process ends.

The content of the processes up to step S37 and the processes after step S39 are the same as that of the first embodiment, and therefore the description thereof is omitted. In addition, the content of the data reception process and the print process is the same as that of the first embodiment, and thus the description thereof is omitted.

According to the second embodiment, an authentication process of a user who intends to use the image forming apparatus 10 is performed, and a printing instruction for the print job with a holding function is permitted only for a user registered in advance, and thus safety can be further improved.

### Third Embodiment

An image forming apparatus 10 of a third embodiment is the same as that of the first embodiment except that print job data with a holding function is automatically deleted when a predetermined time has elapsed after an occurrence of a first type error, and therefore the content different from that of the first embodiment will be described, and redundant description will be omitted.

In the image forming apparatus 10 of the third embodiment, in a case where a first type error occurs, when a predetermined time (for example, 2 to 3 minutes) has elapsed since an occurrence of the first type error, print job data with a holding function is deleted. That is, the print job data with the holding function is not deleted until a predetermined time elapses from the time when the first type error occurs. Therefore, when the first type error is eliminated until the predetermined time elapses since the time when the first type error occurs, the print job is resumed in a state where the print job data with the holding function is registered in the print job table. This is because, if the error is eliminated within a predetermined time, it is highly likely that the user who has executed a print instruction has taken action and it is considered that the user who has executed the print instruction is near the image forming apparatus, and there is no need to delete the print job data with the holding function from the viewpoint of safety, and if the print job data is rather not deleted, there is no need to execute a print instruction again, which is convenient.

In addition, in the third embodiment, in order to perform the operation as described above, a control program stored in the RAM 14 of the image forming apparatus 10 includes a determination program that determines whether a predetermined time has elapsed since the occurrence of the first type error. The above operation of the image forming apparatus 10 is implemented by the CPU 12 executing the control program including the determination program.

While a print process in the third embodiment will be described below with the use of a flowchart, the same processes as the print process described in the first embodiment have the same reference numerals, and redundant content will be omitted or briefly described.

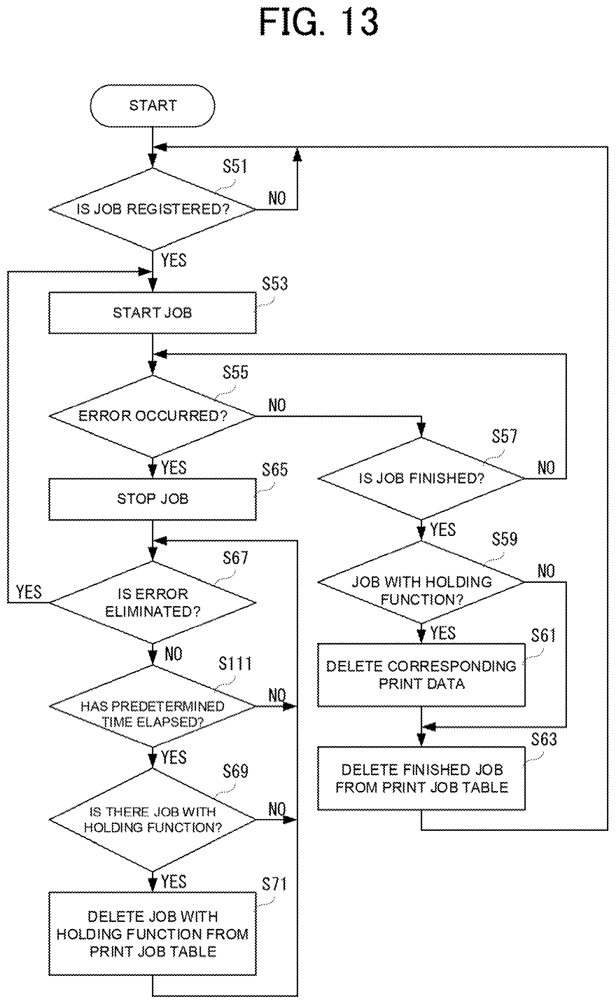

FIG. 13 is a flowchart illustrating an example of a print process of the third embodiment. As illustrated in FIG. 13, when the CPU 12 starts the print process, if “NO” in step S67, it is determined in step S111 whether a predetermined time has elapsed since an occurrence of the first type error. If “NO” in the step S111, that is, if the predetermined time has not elapsed since the occurrence of the first type error, the process returns to step S67. Meanwhile, if “YES” in the step S111, that is, if it is determined that the predetermined time has elapsed since the occurrence of the first type error, the process proceeds to step S69.

The content of the processes up to step S67 and the processes after step S69 are the same as that of the first embodiment, and therefore the description thereof is omitted. In addition, the content of the data reception process and the job registration process is the same as that of the first embodiment, and thus the description thereof is omitted.

According to this third embodiment, print job data with a holding function is automatically deleted when a predetermined time has elapsed after the occurrence of the first type error, and thus in addition to the safety, convenience can be improved.

While, in the third embodiment, print job data with a holding function is automatically deleted when a predetermined time has elapsed after the occurrence of the first type error, the print job data with the holding function may be automatically deleted when the user disappears from a periphery (front) of the image forming apparatus 10 before the first type error is eliminated. In this case, the image forming apparatus 10 includes a human detection sensor for detecting a person (user) present in front of the image forming apparatus 10. As the human detection sensor, for example, a distance sensor, a pyroelectric sensor, a floor sensor (pressure sensor) or a digital camera (image sensor) can be used. For example, as the distance sensor, an infrared sensor, an ultrasonic sensor, a laser distance sensor, or the like is used. The human detection sensor is connected to the CPU 12 via the bus 60. The CPU 12 determines whether the user is present in an area in front of the image forming apparatus 10 in accordance with data output from the human detection sensor, such as distance data, temperature data, and image data.

In addition, the aspect illustrated in the third embodiment can be adopted in combination with the second embodiment.

The specific configurations and the like described in the above-described embodiments are merely examples, and can be appropriately changed in accordance with an actual product. In addition, each step of the flowchart illustrated in the above-mentioned embodiments can be appropriately changed in the process order as long as the same result is obtained.

In addition, while in the above-described embodiments, when a print job is finished, print job data corresponding to the print job is automatically deleted from the print job table, the present invention is not required to be limited to this. Although not illustrated, when the print job is finished, a selection window for allowing the user to select whether to delete the print job data corresponding to the print job may be displayed on the display 22 and the user may select whether to delete the print job data. In addition, the selection window may be hidden if a state where there is no user's input operation continues for a predetermined time after the selection window is displayed. When the selection window is hidden, the print job data may be automatically deleted, or the print job data may not be deleted.

Moreover, while in the above-described embodiments, when a first type error occurs during execution of a print job with a holding function, print job data with a holding function corresponding to the print job is deleted, the present invention is not required to be limited to this. When the first type error occurs during execution of the print job with the holding function, the print job may be temporarily suspended without deleting print job data with the holding function, and the print job may be resumed if the first type error is eliminated. In this case, for a user who has executed the print job with the holding function or a user who should receive a printed matter of the print job with the holding function, it is desirable to inform that the print job with the holding function will be resumed/has resumed, or that there is the printed matter of the print job with the holding function. For example, when the image forming apparatus 10 includes a speaker, the information may be notified by sound or voice, or when a destination of an information terminal used by the user is registered in the image forming apparatus 10, it may be notified by e-mail.

Furthermore, while in the above-described embodiments, when a list of received print data with a holding function is displayed, a thumbnail image based on a print image included in the received print data with the holding function is displayed, this thumbnail image may not be displayed. In this case, information on a transmission source of the received print data with the holding function, information related to the print image, or the like is displayed in the list.

In addition, a function for automatically deleting print job data when a first type error occurs (automatic deletion function) may be enabled/disabled. For example, the enable/disable of the automatic deletion function can be switched by a predetermined key operation, and the key for switching the enable/disable of the automatic deletion function (automatic deletion function switching key) may be a hardware key or a software key. However, when the automatic deletion function is enabled, it is desirable that a message prompting to enable a holding function is displayed on the display 22 or output by voice.

What is claimed is:

1. An image forming apparatus, comprising:
an image former that executes a print job in accordance with print job data registered in a print job table;
a receiver that receives print data transmitted from an external terminal;
a switcher that switches between enabling and disabling a holding function of executing the print job for the print data only when a predetermined user operation is received;
a registerer that registers, in the print job table, print job data with a holding function based on print data with a holding function that is received in a state where the holding function is enabled, among the print data received by the receiver, when the predetermined user operation is received;
a detector that detects a predetermined error not suitable for an execution of the print job; and
a deleter that deletes the print job data with the holding function from the print job table when the predetermined error is detected by the detector.

2. The image forming apparatus according to claim 1, further comprising a storage that stores the print data with the holding function,
wherein when the predetermined user operation is received, the registerer reads the print data with the holding function from the storage, and registers the print job data with the holding function in the print job table.

3. The image forming apparatus according to claim 1, further comprising:
a display; and
a previewer that causes the display to preview a print image corresponding to the print data with the holding function.

4. The image forming apparatus according to claim 2, further comprising:
a display; and
a previewer that causes the display to preview a print image corresponding to the print data with the holding function.

5. The image forming apparatus according to claim 1, further comprising a permitter that performs an authentication process of a person who intends to use the image forming apparatus and permits the predetermined user operation only for a person registered in advance.

6. The image forming apparatus according to claim 2, further comprising a permitter that performs an authentication process of a person who intends to use the image forming apparatus and permits the predetermined user operation only for a person registered in advance.

7. The image forming apparatus according to claim 3, further comprising a permitter that performs an authentication process of a person who intends to use the image forming apparatus and permits the predetermined user operation only for a person registered in advance.

8. A non-transitory computer-readable recording medium storing a control program for an image forming apparatus including an image former that executes a print job in accordance with print job data registered in a print job table,
the control program causing a processor of the image forming apparatus to function as:
a receiver that receives print data transmitted from an external terminal;
a switcher that switches between enabling and disabling a holding function of executing the print job for the print data only when a predetermined user operation is received;
a registerer that registers, in the print job table, print job data with a holding function based on print data with a holding function that is received in a state where the holding function is enabled, among the print data received by the receiver, when the predetermined user operation is received;
a detector that detects a predetermined error not suitable for an execution of the print job; and
a deleter that deletes the print job data with the holding function from the print job table when the predetermined error is detected by the detector.

9. A control method for an image forming apparatus including an image former that executes a print job in accordance with print job data registered in a print job table, the control method comprising:
(a) receiving print data transmitted from an external terminal;
(b) switching between enabling and disabling a holding function of executing the print job for the print data only when a predetermined user operation is received;
(c) registering, in the print job table, print job data with a holding function based on print data with a holding function that is received in a state where the holding function is enabled, among the print data received in the (a), when the predetermined user operation is received;
(d) detecting a predetermined error not suitable for an execution of the print job; and
(e) deleting the print job data with the holding function from the print job table when the predetermined error is detected in the (d).
